(19) United States
(12) Patent Application Publication
(10) Pub. No.: US 2004/0053031 A1
(43) Pub. Date: Mar. 18, 2004

(54) Heat/sound insulation product based on mineral wool and method

(76) Inventors: Sebastien Beaufils, Cernoy (FR); Claire Calero, Erquery (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/312,804

(22) PCT Filed: Jul. 12, 2001
(86) PCT No.: PCT/FR01/02282

(30) Foreign Application Priority Data
Jul. 13, 2000 (FR) 00/09268

(51) Int. Cl. B32B 3/26

(52) U.S. Cl. 428/304.4

(57) ABSTRACT

The invention concerns a method for making a heat and/or sound insulation product based on mineral wool by internal centrifuge, with a production line comprising n fibre drawing members in series, which consists in adjusting differently at least one fibre drawing parameter of two successive fibre drawing members on the production line. The invention also concerns the resulting products.

The present invention relates to thermal and/or acoustic insulation products based on mineral wool, especially based on glass wool or basalt wool.

It also relates to the method of obtaining them, especially using a process called centrifuging. This process consists, in a known manner, in introducing a stream of molten glass into a spinner, also called a fiberizing dish, rotating at high speed and pierced around its periphery with a very large number of holes through which the glass is thrown out in the form of filaments owing to the effect of the centrifugal force. These filaments are then subjected to the action of an annular high-velocity extending blast of hot gases hugging the wall of the spinner, which blast attenuates the filaments and converts them into fibres. The fibres formed are entrained by this extending blast of gases to a receiving device, generally consisting of a gas-permeable belt. For greater details about this process, reference may be made in particular to patents EP-0,189,354, EP-0,519,797 and EP-0,406,107.

The invention applies both to so-called “light” insulation products, that is to say those generally having a density of at most 40 kg/m³, and to so-called “heavy” insulation products, having a density greater than 40 kg/m³ till for example 160 kg/m³, whether or not they are covered over at least part of their external surface with a facing.

A number of these products, especially depending on their shape, their density and the amount of sizing used, are classified and defined in the NFB 20-001 August 1998 standard. In fact, these various products are often the result of compromises between various parameters, especially their mechanical properties and their insulation properties, which compromises are tailored to the envisaged applications.

Thus, it may be necessary to have insulation products which are particularly high-performance in terms of mechanical properties: these are especially insulation products which support masonry elements and which must consequently withstand high compressive forces such that the elements serving for the insulation are flat roofs able to be walked upon. This is also the case with products used for exterior insulation, which must be able, in particular, to withstand tearing forces. In this case, “heavy” products are preferred in which the mineral wool has a generally high micronaire value.

On the other hand, if these products are not intended to be highly mechanically stressed (for example products for insulating roofs between rafters) “light” products are preferred, these being easier to handle and superior from the thermal insulation standpoint, the mineral wool of which generally has a lower micronaire value and/or a greater fibre length, and/or a lower level of sizing.

However, any compromise has its limits. The object of the invention is therefore to push back these limits, that is to say to propose novel products (and their manufacturing process) which are improved, in which it is possible especially to adjust their properties more finely or more flexibly, or in which it is possible to give the fibres novel functionalities.

The subject of the invention is firstly a thermal and/or acoustic insulation product based on mineral wool, of the type of those described above, but which exhibits, within its thickness, variations in at least one of its characteristics, especially in the geometry of the mineral wool fibres or in the chemical composition of the mineral wool.

These variations may lead, within the thickness of the product, to variations in its properties, most particularly in its mechanical properties and/or its thermal/acoustic insulation properties. They may also lead to improve its reaction/resilience towards fire, or confer superficially to the product hydrophobic properties, or any kind of properties by modification or addition of one or more agents in a gluing step.

The invention has thus revealed the advantage of an insulation product whose properties vary within its thickness. It is also a composite product in its characteristics/in its properties. It is also possible to indicate differences in the product in terms of its surface properties and its “core” properties, while still having a product that can be devided into different “layers”, but that nevertheless has the internal cohesion of standard insulation products.

The insulation products targeted by the invention are, in particular, those listed in the aforementioned standard. These are especially “felts”, namely made of flexible sized mineral wool supplied in the form of “rolls” or of “sheets” generally between 20 and 300 mm in thickness. They may also be “stitched blankets” which are based on lightly sized mineral wool covered on at least one face with a facing, or “panels” which are based on rigid or semi-rigid sized mineral wool. These products all generally have an approximately parallelepipedal shape.

The invention may also apply to products of different geometrical shapes, such as “segments”, which are plane elements of trapezoidal cross section. They may also be products used for insulating pipes, known as “shells” (annular cylinders made of one or two elements) or as “staves” (parts of a cylinder, the cross section of which is an annular sector). In general, within the context of the invention and in the rest of the present text, and for the sake of brevity, although the term “felt” is used it also encompasses, by extrapolation, the abovementioned similar products.

Taking therefore the example of a felt, approximately parallelepipedal in shape, this has two main external faces.

According to an embodiment of the invention, the felt has, on at least a part of its thickness, layers having different characteristics/properties. The felt may comprise at least two adjacent layers (coming from two different fiberizing devices), which have different fiber sizes, different compositions. The product may comprise n layers, each layer x being in contact with at least another different layer x+1. Of course, between two layers there is a “diffuse” interface, in the sense that they are interlayered, the product remaining coherent.

According to one embodiment of the invention, the felt has, on at least one part of one of its external faces, a “surface layer” having different characteristics/properties from those of the product in the core.

This surface layer may, for example, consist of a mineral wool whose fibres have a lower micronaire value (or diameter) than those of the mineral wool of the rest of the product. There are two advantages: firstly, it turns out that surface fibres thus attenuated are more flexible and more agreeable to touch. This is advantageous when the external surface in question is not intended to be covered with a facing. Secondly, attenuation of the surface fibres may have a favourable impact on the thermal insulation capacity of the product in its entirety. As regards the core fibres, which are finer, these are optimized more from the standpoint of mechanical considerations.

This surface layer may also consist, as an alternative or in combination, of mineral wool whose fibres are longer than in the rest of the product. It has thus been shown that by having more elongate surface fibres the feel was further improved. One hypothesis for explaining this is that more elongate fibres present overall fewer ends which are all “catching” points that may be felt when passing one's hand over the product.

Modifying the dimensions only of the surface fibres allows the mechanical properties of standard insulation products to be maintained.

This surface layer may, as an alternative or in combination with the abovementioned characteristics, also be chemically modified.

As is known, the insulation products of interest in the invention are preferably provided throughout their thickness with a sizing composition whose function is especially to ensure cohesion of the product by creating inter-fibre bonds. The sizing compositions generally contain resins based on phenol, formaldehyde and urea. The inventors became aware that this sizing, although extremely useful, helped to give the surface a slightly rigid and brittle feel.

To improve this feel, the mineral wool was provided with a sizing composition throughout its thickness, but with a smaller amount in the “surface layer” defined above: the product is thus made more agreeable to touch, by sufficiently moderately lowering the sizing content on the surface of the product for there to be no negative impact on its internal cohesion.

Another way of modifying the chemical composition of the mineral wool on the surface consists in impregnating it with an additional composition having softening properties. This composition preferably comprises at least one surfactant, especially at least one surfactant of the family of cationic surfactants, the latter proving to be the most effective. In the context of the invention, the term “cationic surfactant” should be understood to mean not only a surfactant carrying a localized positive charge (a “true” cationic salt such as, for example, an imidazolinium salt) but also a surfactant carrying a delocalized charge (such as, for example, an amine oxide). Within this family, products having one or more chains based on fatty acids or on fatty acid derivatives and including one or more nitrogen-containing groups capable of carrying a localized or delocalized positive charge are especially preferred. These groups may be primary amines, secondary amines or tertiary amines, quaternary ammoniums or amine oxides. They seem particularly beneficial as they interact with the surface of the glass, which surface is somewhat ionized negatively. This chemical functionality would give the molecule the ability to be lastingly fixed to the fibre, while the fatty chains would give it the desired softness.

The most beneficial surfactants are, for example, quaternary ammonium salts or imidazolinium salts having fatty chains (with an acetate-type counterion, for example) or amine oxides having fatty chains (for example, stearyl dimethyl amine oxide), with a dative bond between the oxygen and the nitrogen. The fatty chains (hydrocarbons) are fatty acid derivatives, which are of CH₃(CH₂)ₙCOOH type when they are saturated. There are also unsaturated fatty acids. Examples of fatty acids whose derivatives can be used in the surfactant composition according to the invention are: stearic acid, lauric acid, palmitic acid, myristic acid. Mention may also be made of unsaturated fatty acids such as oleic or linoleic acid. Carbon chains may be branched.

It is also possible to use, alternatively or cumulatively, non-ionic surfactants like fatty esters.

Treating only the surface of the product with this softening composition has two considerable advantages:

[symbol] firstly, it was shown that the presence of surfactant throughout the thickness of the material was unnecessary to obtain the sought after effect;

[symbol] secondly, it is simpler and less expensive to treat only part of the product, for example at the end of a line, on each of its faces rather than having to treat it right to the core;

[symbol] thirdly, it is thus possible to apply, to the surface of the product, a softening composition whose active principle—the surfactant—would be incompatible with uncrosslinked sizing composition.

The invention also pertains to objectives other than a more agreeable feel, and especially to the mechanical properties of the product.

The “surface layer” defined above may thus consist of mineral wool whose fibres have a higher micronaire value, or larger diameter, than in the core of the product. This results in the external surface of the product being mechanically strengthened. This is particularly advisable when the product in question is intended to be rolled. In this case, if its “external” surface (i.e. the side that is visible once the roll has been formed) is strengthened in this way, it is more capable of withstanding the high mechanical stresses involved when the felt is rolled up on itself).

In all the particular cases of modified surface layers described above, it is preferred to have those modifications which affect only a small thickness of the insulation product, for example at most 2 to 4 cm, or even 1 to 10 mm. This thickness may thus represent at most only one fifth or one sixth of the total thickness of the felt (these figures having to be multiplied by two if the product is surface-modified on both its main faces and not just on one).

It is also within the scope of the invention for these modifications, whether they relate to the geometry of the fibres or to their chemical composition, to be obtained progressively through the thickness of the product: it is thus possible to have a sizing concentration gradient and a gradual increase or decrease in the diameter or in the length of the fibres.

Nor is the invention limited to a modification relating exclusively to the surface regions of the product: there may be in the product a succession of “layers” whose characteristics vary from one layer to another, in the manner of a multilayer composite product.

The subject of the invention is also a process for manufacturing a thermal and/or acoustic insulation product based on mineral wool (especially that described above), by internal centrifuging. According to the invention, a production line comprising n fiberizing members in series is used and at least one fiberizing parameter of two successive fiberizing members in the line are set differently.

As is explained in detail especially in the patents cited in the preamble to the present application, lines for producing glass wool by internal centrifuging generally comprise a plurality of spinners in series (in general, between 2 and 8 spinners). The fibres which are expelled therefrom owing to the effect of the centrifugal force are collected on receiving members of the suction belt type. The fibres coming from each spinner building up in successive layers on the belt which then takes them through an oven and/or shaping cutters. The thermal treatment undergone during passage through the oven makes it possible to dry/crosslink/cure the sizing composition sprayed onto the fibres just below the spinner before they have been collected.

By setting at least one of the fiberizing members differently from the others, it is thus possible to give at least one of the “sheets” of fibres characteristics which are different from the others and thus to obtain the multilayer composite product mentioned above. This is an ingenious solution, which makes it possible to achieve much greater flexibility in the properties of the insulation product, without correspondingly upsetting the operation of a standard production line.

When one or more fiberizing parameters of the first (or of the first two) and/or of the last (or last two) fiberizing members are thus modified, the product described above, with one or two different surface layers, is obtained, namely a product whose surface may be provided with an additional functionality or have properties different from that of the product at the core (appearance/more agreeable feel, mechanical strength, thermal, acoustic, esthetic properties . . . ).

Within the context of the invention, the term “first member” and “last member” should be understood to mean those members which are located in the line respectively furthest upstream and furthest downstream, or else the members which manufacture, respectively, the sheet of fibres which will lie closest to and furthest away from the surface of the conveyor belt (or of any other type of means of conveyance) for the fibre mattress composed of all of the fibre layers coming from the centrifuging members.

If the conventional construction of the type of fiberizing member used in the invention is adopted, it comprises:

[symbol] a spinner capable of rotating about an axis, especially a vertical axis, the peripheral band of the spinner being pierced with a plurality of holes;

[symbol] a hot-gas extending means in the form of an annular burner;

[symbol] optionally, a pneumatic means for channelling/adjusting the dimension of the fibres, in the form of a blowing ring; and

[symbol] optionally, a means for applying a sizing composition to the fibres coming from the spinner, for example in the form of a sizing spray ring.

The fiberizing parameter that may be set differently depending on the fiberizing member is advantageously chosen from one of the following parameters:

[symbol] the amount or the nature of the sizing composition delivered by the means for applying the said composition;

[symbol] the pressure of the gases emitted by the annular burner;

[symbol] the pressure of the gases emitted by the blowing ring; and

[symbol] the number (and/or the size and distribution) of the holes in the spinner.

It is possible to modify in addition other parameters, such as the temperature of the gases emitted at the outlet from the annular burner, the velocity of the gases emitted by the annular burner, the temperature of the fiberizing member, the chemical glass composition . . . .

Another type of modification to the fiberizing conditions (which can be combined with the previous ones) consists in adding an additional step, namely the application, to the fibres coming from the spinner in question, of a composition having softening properties, especially one containing a cationic-type surfactant. This application may be accomplished using a spray ring similar to that which may be used for applying the sizing composition: such a treatment makes it possible to give the product a softer feel.

According to one embodiment, two parameters may be modified, as alternatives or in combination, in order to create layers in the product which have longer fibres than in the other layers. It is preferred to modify the parameters of the first (or of the first two) and/or of the last (or of the last two) fiberizing members so that the product has one surface layer (on one of its faces) or two surface layers (on each of its faces).

To do this, it is advantageous to modify:

the pressure of the gases expelled by the blowing ring of the said spinner or spinners.

It is also possible to reduce the pressure of the gases emitted by the blowing ring compared with the other blowing rings in the line, such as especially a reduction of at least 20% and preferably of between 30 and 50% compared with those of the other rings. This is because a lower pressure will tend to break the fibres less and to preserve their length.

Longer fibres are softer to the touch.

According to a second embodiment, attempts may be made to attenuate the fibres (reduce their micronaire value) by modifying, as alternatives or in combination, two other fiberizing parameters of some of the fiberizing members, especially of the first or of the first two and/or last or last two fiberizing members, namely:

[symbol] the pressure of the gases emitted by the annular burner;

[symbol] the holes in the spinner.

Thus, it is possible to increase the pressure of the annular burner by, for example, 10 to 25% over and above that of the other burners, thereby increasing the velocity of the extending gases and thus increasing the fineness of the fibres. It is also possible to increase the number of holes in the dish of the spinner, for example by 15 to 25% over and above the number of holes in the other dishes: with the burner pressure kept the same as the others, the same tendency to cause fibre attenuation is observed.

A product may thus be obtained which, on at least one of its faces, has fibres on the surface that are thinner, and especially softer to the touch.

If instead it is desired to mechanically strengthen at least one of the faces of the product, it is possible on the other hand to have fibres with a higher micronaire value or larger diameter.

This higher micronaire may also improve the gluing of a supporting sheet on the insulating felt, or help print any king of information at the surface

In this case, the pressure of the burner(s) mentioned above will be reduced, especially by 10 to 20% with respect to the other burners, and/or the number of holes in the spinner(s) mentioned above will be reduced, for example by 15 to 25% with respect to the other spinners.

According to another embodiment, it is possible to use less sizing in part of the insulation product, especially in the surface regions of the final product. To do this, a smaller amount of sizing composition may in fact be sprayed onto the fibres coming from the first and/or from the last fiberizing member compared with all the other fiberizing members. The reduction may, for example, be of the order of at least 10 to 20% by weight.

The invention will be described in detail below with the aid of the following figures:

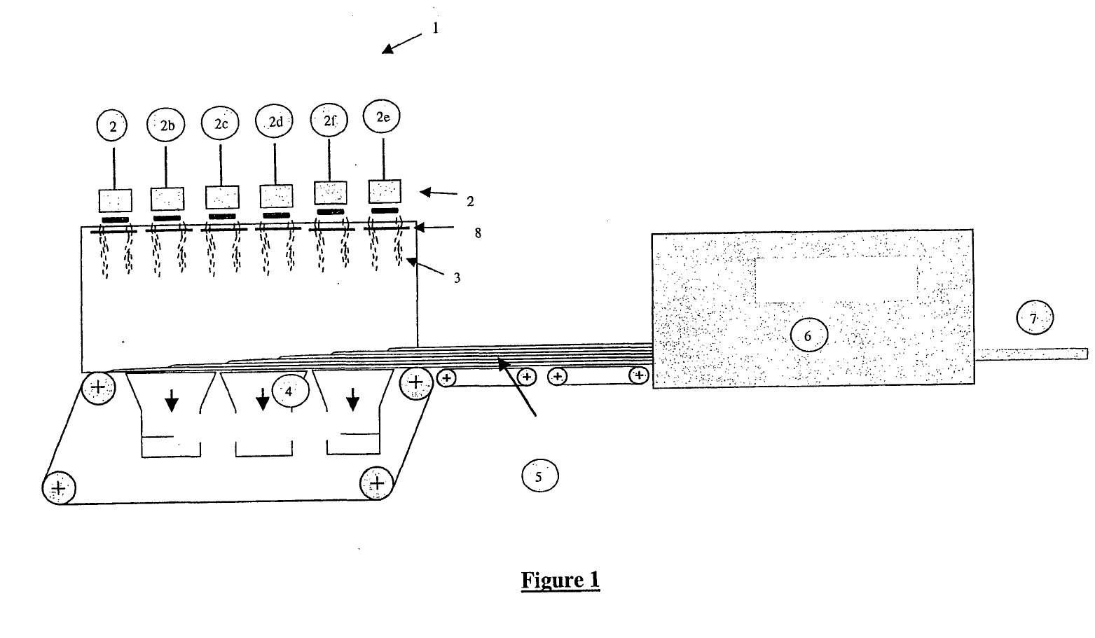

FIG. 1: a schematic view of a line for producing glass wool by internal centrifuging;

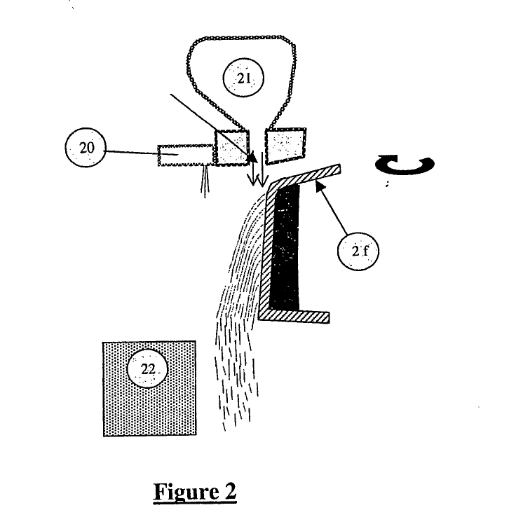

FIG. 2: a schematic view of a spinner of the said line.

The figures are intentionally highly schematic and are not drawn to scale in order to make them easier to examine.

The non-limiting illustrative examples which follow all relate to the manufacture of glass wool felts having a density of approximately 8 to 12 kg/m³ and dimensions of 60 mm×80 mm×120 mm, which are manufactured on a production line of the type illustrated highly schematically in FIG. 1. In some cases, these felts may be provided on one of their faces with a facing of the kraft paper type (for example).

Referring to FIG. 1, this therefore shows a line 1 comprising six spinners 2a, 2b, 2c, 2d, 2e, 2f in series, from which fibres 3 are expelled in the form of a torus. These fibres are sized using spray rings 8 and then collected on a suction conveyor belt 4. This belt conveys them in the form of a continuous web 5 as far as an oven 6 which is provided with shaping rollers and which cures the size on the fibres and gives the felt 7 the desired dimensions and thickness. After leaving the oven, the continuous web of felt will then be cut up into approximately parallelepipedal panels and then packaged as rolls or packaged as folded or as unfolded sheets (the end of the line has not been shown).

### EXAMPLE 1

The aim in this example is to give the felt a particularly agreeable and soft feel on one of its faces, that which is not to be covered with a facing, without moreover significantly modifying the other properties of the felt (mechanical properties and thermal insulation properties).

The operation of a spinner, as illustrated in FIG. 2, will not be described here in detail. It is described in the aforementioned patents. It will be recalled that it is surrounded by an annular burner 21 emitting a high-velocity jet of hot gases and by a blowing ring 20. The sizing ring has not been shown. Optionally, a device for heating the lower part of the spinner, in the form of a magnetic induction ring 22, is used.

The gases emitted by the blowing ring 20 associated to the last spinner 2f is therefore modified so that the fibres on the surface have a lower micronaire value than in the rest of the thickness of the felt, on one of its faces.

The speed of rotation of the spinners 2a to 2e is set at 1900 rpm.

The speed of rotation of the spinner 2f was increased to 2200 rpm.

The pressure of the blowing rings of the spinners 2a to 2e is 1.2 bar.

The pressure of the blowing ring of the spinner 2f was reduced to 0.5 bar (taking care that this reduction did not excessively enlarge the torus of fibres leaving the spinner, so as to avoid any risk of the fibres coming into contact with the inductor 22).

In fact, the felt obtained has, once it has passed between the shaping rollers and through the oven, a surface layer of approximately 2 to 5 mm (the total thickness of the felt being 60 mm) in which the fibres have a micronaire value reduced by 0.2 compared with the rest of the felt. It is difficult to evaluate the length of the fibres using standard analytical techniques. However, it has been verified that the surface of the product thus modified was softer. Its mechanical properties are unchanged compared with a standard felt.

### EXAMPLE 2

The aim of this example is to chemically modify the surface of the felt, on that side of its external face which is not to be provided with a facing.

A solution of the following softening composition is used:

aqueous phase;

cationic surfactant containing 0.025%, 0.05% and 0.1% by weight with respect to the aqueous phase, consisting of a surfactant comprising 90% amide amine acetate having fatty chains and 10% acetic acid.

The acetate has the following chemical formula: N-[2[[2-[[2-[(2-aminoethyl)amino]ethyl]amino]ethyl]amino]ethyl]-octadecanamide, monoacetate (9Cl) of molecular formula C₂₆H₅₇N₅O.C₂H₄O₂.

This product is in the form of water-soluble flakes.

According to a first variant, a second spray ring fed with this softening composition is added below the sizing ring of the last spinner 2f.

According to a second variant, this composition was sprayed using a spray boom above the fibre mattress, just before it entered the crosslinking oven.

According to a third variant, this composition was sprayed above the fibre mattress, just after the crosslinking oven.

According to the second variant, tests were carried out so that the surfactant content on the surface of the product was approximately 0.2 g/m² of treated surface. The composition impregnated the felt to a thickness of approximately 1 to 2 mm.

It was confirmed that those faces of the felts thus treated have a particularly agreeable feel. The mechanical properties of the product are not affected.

The above examples relate to one type of glass wool production line, but the invention is not limited to this particular type. It may apply in the same way to glass wool felts manufactured on a line in which the spinners are grouped in modules with, for each module, a system for receiving the fibres coming from the spinners using rollers. A detailed description of this type of line will be found in the aforementioned patent EP-B-0,406,107: corresponding to each “module” is the formation of a “primitive”, and all the primitives are gathered together before being taken in the form of a single felt into the oven.

In conclusion, the invention has made it possible to demonstrate the advantage of having mineral wool insulation products whose properties may be modified on the surface (or within the actual thickness of the product). Not having all the fiberizing members in the line operating with the same parameters is a very novel concept, which makes it possible to make products having differentiated “layers”, especially in order to achieve better compromises between mechanical properties, thermal properties and appearance properties.

1. Process for manufacturing a thermal and/or acoustic insulation product based on mineral wool by internal centrifuging, with a production line comprising n fiberizing members in series, characterized in that at least one fiberizing parameter of two successive fiberizing members in the production line are set differently.

2. Process according to claim 1, characterized in that at least one fiberizing parameter of the first or of the first two and/or of the last or of the last two fiberizing members are set differently from the setting adopted for the other fiberizing members of the line.

3. Process according to claim 1 or claim 2, characterized in that each production member comprises: [symbol]
a spinner capable of rotating about an axis, especially a vertical axis, the peripheral band of the spinner being pierced with a plurality of holes; [symbol]
a hot-gas extending means in the form of an annular burner; [symbol]
optionally, a pneumatic means for channelling the fibres, in the form of a blowing ring; and [symbol]
optionally, a means for applying a sizing composition to the fibres coming from the spinner, for example in the form of a sizing spray ring.

4. Process according to claim 3, characterized in that the fiberizing parameter that is set differently depending on the fiberizing member is chosen from at least one of the following parameters: [symbol]
the amount or the nature of the sizing composition delivered by the means for applying the said composition; [symbol]
the pressure of the gases emitted by the annular burner, [symbol]
the pressure of the gases emitted by the blowing ring, [symbol]
the number of holes in the spinner, [symbol]
the chemical glass composition, the viscosity, the temperature, [symbol]
the temperature or the speed of the gases emitted by the annular burner, [symbol]
the temperature of the spinner.

5. Process according to one of the preceding claims, characterized in that the fiberizing parameter that is adjusted differently is the addition, for one or more fiberizing members, of a step of applying a composition having softening properties, containing a cationic-type surfactant and/or non ionic surfactant, especially by a means of the spray ring type.

6. Process according to claim 3 or 4, characterized in that: [symbol]
the pressure of the gases emitted by the blowing ring of the first and/or of the last fiberizing member is less than that of the other fiberizing members, especially at least 20% and preferably between 30 and 50% less, especially so that the insulation product has a surface layer, on at least one part of its external surface, having longer fibres.

7. Process according to claim 3, 4 or 6, characterized in that: [symbol]
the pressure of the gases expelled by the annular burner of the first or of the first two and/or of the last or of the last two fiberizing members is greater than that of the burners of the other members, especially approximately 10 to 25% greater; [symbol]
and/or the number of holes in the spinner of the first or of the first two and/or of the last or of the last two spinners is greater than that in the other spinners, especially 15 to 25% greater, especially so that the insulation product has a surface layer with, on at least one part of its external surface, fibres having a smaller diameter or lower micronaire value.

8. Process according to claim 3, 4 or 6, characterized in that: [symbol]
the pressure of the gases emitted by the annular burner of the first or of the first two and/or of the last or of the last two fiberizing members is less than that of the burners of the other members, especially approximately 10 to 25%. [symbol]
and/or the number of holes in the spinner of the first or of the first two and/or of the last or of the last two spinners is less than that in the other spinners, especially having 15 to 25% holes less, especially so that the insulation product has a surface layer with, on at least one part of its external surface, fibres having a larger diameter or higher micronaire value.

9. Process according to one of claims 3, 4, 6, 7 or 8, characterized in that a smaller amount of sizing composition is sprayed onto the fibres coming from the first or from the first two and/or from the last or from the last two fiberizing members, especially at least 10 or 20% less sizing composition, so that the insulation product has, on the surface, on at least one part of its external surface, a lower sizing content than within its thickness.

10. Thermal and/or acoustic insulation product based on mineral wool, obtained especially by the process according to one of the preceding claims, characterized in that it exhibits, through its thickness, variations in at least one of its characteristics, especially variations in the size of the fibres of the mineral wool or in the chemical composition of the said mineral wool.

11. Thermal and/or acoustic insulation product based on mineral wool, obtained especially by the process according to one of the preceding claims, characterized in that it exhibits, through its thickness, variations in its mechanical properties and/or its thermal/acoustic insulation properties, and/or in its capacity to react or resist fire and/or in its hydrophobicity.

12. Thermal and/or acoustic insulation product according to claim 10 or claim 11, characterized in that that it is in the form of a felt having layers having different characteristics/properties, and having notably on at least one of its faces, a surface layer with characteristics/properties which are different from those of the product at its core.

13. Thermal and/or acoustic insulation product according to claim 12, characterized in that the fibres of the mineral wool have a lower micronaire value or a smaller diameter and/or a greater length on a surface layer of at least one of the faces of the said product, especially so as to give the said product a more agreeable feel.

14. Thermal insulation product according to claim 12 or claim 13, characterized in that the fibres of the mineral wool have a lower and/or different content of sizing composition and/or are impregnated with an additional composition having softening properties, comprising a surfactant, on a surface layer of at least one of the faces of the said product, especially so as to give the said product a more agreeable feel.

15. Thermal and/or acoustic insulation product according to claim 12, characterized in that the fibers of the mineral wool have a higher micronaire value or a larger diameter on a surface layer of at least one of the faces of the said product, especially so as to give the said product a mechanically strengthened external superficial layer and/or to improve the gluing of a supporting sheet and/or to improve the printing of information an said superficial layer.

16. Insulation product according to claim 15, characterized in that it is a felt which is to be rolled, its external surface being mechanically strengthened.

17. Use of the process according to one of claims 1 to 9 for obtaining a thermal/acoustic insulation product having thermal/mechanical/chemical or resistance towards fire or hydrophobicity or appearance properties which vary through its thickness.
